(19) United States
(12) Patent Application Publication
(10) Pub. No.: US 2016/0052172 A1
(43) Pub. Date: Feb. 25, 2016

(54) Method of Manufacturing a High Performance Polymer and Nanotube Composite

(71) Applicant: N1 Technologies, Daytona Beach, FL (US)

(72) Inventor: Roc Hatfield, Safety Harbor, FL (US)

(21) Appl. No.: 14/933,271

(22) Filed: Nov. 5, 2015

Related U.S. Application Data
(60) Provisional application No. 62/075,294, filed on Nov. 5, 2014.

(51) Int. Cl. B29B 9/12; B29B 9/06; C08K 3/30

(52) U.S. Cl. CPC B29B 9/12; C08K 3/30; B29B 9/06; C08K 2003/3009; B29K 2077/00

(57) ABSTRACT

A method of manufacturing a high performance polymer and nanotube composite is used to produce a nylon resin polymer with favorable material properties over traditional resin polymers. A plurality of tungsten sulfide nanotubes is combined with a plurality of nylon resin pellets which are ground up into a nylon resin powder. A heterogeneous mixture of the nylon resin powder and the plurality of tungsten nanotube is heated within a plastic extrusion machine such that the nylon resin powder melts and envelopes the plurality of tungsten sulfide nanotubes. With the plurality of tungsten sulfide nanotubes suspended in the fluid nylon resin, the heterogeneous mixture is extruded from the plastic extrusion machine as a pultrusion. The pultrusion is segmented into a plurality of polymer composites as the plutrusion solidifies from cooling for various materials applications.

The current application claims a priority to the U.S. Provisional Patent application Ser. No. 62/075,294 filed on Nov. 5, 2014.

### FIELD OF THE INVENTION

The present invention relates generally to a method of manufacturing a high performance polymer and nanotube composite. More specifically, the present invention relates to a high performance polymer which integrates nanotubes into its structure increasing the durability, thermodynamic properties, and tensile strength for the polymer.

### BACKGROUND OF THE INVENTION

The demand for lighter, more durable, and less expensive building materials is constantly increasing in order to cut costs but improve the quality of projects. Researchers are constantly developing new materials to meet the needs for situational applications. Polymers have been proven to be versatile thermoplastics which are applicable over a wide temperature range. Polyamides, specifically, have favorable physical properties including strength, ductility, and heat resistance. Some polyamides can easily be processed and molded for specific applications.

The present invention is a method of manufacturing a high performance polymer and nanotube composite improving the material properties for polyamides with the inclusion of tungsten sulfide nanotubes. The tungsten sulfide nanotubes strengthen the polymer to create a plastic with properties not found in either material individually.

### BRIEF DESCRIPTION OF THE DRAWINGS

FIG. 1 depicts a flow diagram detailing the steps within the present invention.

FIG. 2 exemplifies the cylindrical lattice structure for each of the plurality of tungsten sulfide nanotubes.

FIG. 3 exemplifies a tungsten sulfide nanotube of the plurality of tungsten sulfide nanotubes being concentrically positioned within another tungsten sulfide nanotube of the plurality of tungsten sulfide nanotubes.

### DETAIL DESCRIPTIONS OF THE INVENTION

All illustrations of the drawings are for the purpose of describing selected versions of the present invention and are not intended to limit the scope of the present invention.

The present invention is a method for manufacturing a high performance polymer and nanotube composite. The high performance polymer increases durability, stronger tensile strength and more favorable thermodynamic properties over typical plastic injection materials with the inclusion of tungsten sulfide nanoparticles. In order to execute the steps of the present invention, the present invention requires the following: a plurality of nylon resin pellets, a plurality of tungsten sulfide nanotubes, and a plastic extrusion machine. The plurality of nylon resin pellets is the base for the composite. The plurality of tungsten sulfide nanotubes is suspended within the composite to strengthen the material properties of the nylon resin. A reduced form of the plurality of nylon resin pellets and the plurality of tungsten sulfide nanotubes become the composite through implementation of the plastic extrusion machine.

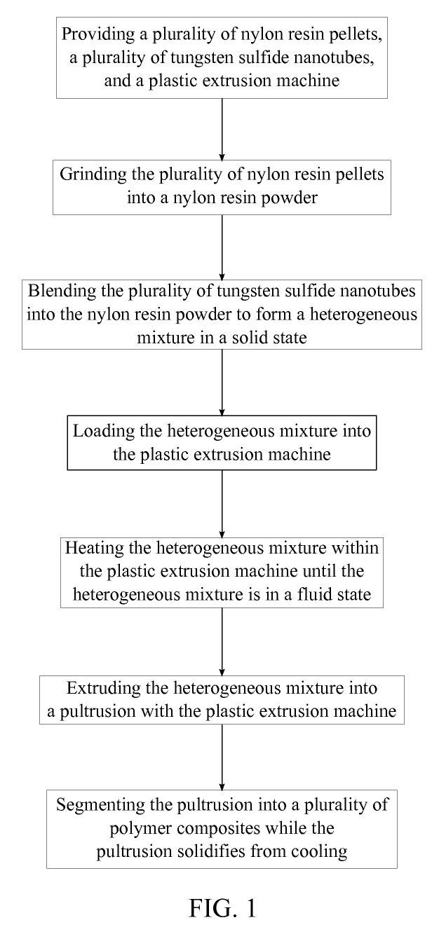

In accordance to FIG. 1, the method of manufacturing a high-performance polymer and nanotube composite begins by grinding the plurality of nylon resin pellets into a nylon resin powder. The plurality of nylon resin pellets is preferred to be a polyamide 6/6 polymer, which is a versatile thermoplastic. In addition, the nylon resin powder is preferably a fine grain powder. Reducing the particle size through grinding changes the thermodynamic properties the nylon resin powder. The decreased particle size allows each of the nylon resin particulates to be thoroughly heated more efficiently. Once the plurality of nylon resin pellets has been reduced into nylon resin powder, the plurality of tungsten sulfide nanotubes is blended into the nylon resin powder to form a heterogeneous mixture in a solid state, wherein both the nylon resin powder and the tungsten sulfide nanotubes are in a solid state. In accordance to the preferred embodiment, the heterogeneous mixture is approximately 80% by weight (wt.) of the nylon resin powder and approximately 20% wt. of the plurality of tungsten sulfide nanotubes. This compositional ratio provides sufficient quantities for both the nylon resin powder and the plurality of tungsten sulfide nanotubes such that there is a significant concentration of the plurality of tungsten sulfide nanotubes which is evenly distributed throughout the nylon resin powder.

Subsequent to forming the heterogeneous mixture, the heterogeneous mixture is loaded into the plastic extrusion machine. Within the plastic extrusion machine, the heterogeneous mixture is heated until the heterogeneous mixture is in a fluid state, where the nylon powder has melted into a fluid state and the plurality of tungsten sulfide nanotubes is suspended within a fluid nylon resin. The heterogeneous mixture is then extruded into a pultrusion with the plastic extrusion machine by forcing the heterogeneous mixture through a die of the plastic extrusion machine. The die shapes the pultrusion into a specific desired shape. As the pultrusion is forced past the die and exposed to the atmosphere, the pultrusion begins to cool. The pultrusion is segmented into a plurality of polymer composites while the pultrusion solidifies from cooling. The pultrusion is segmented as the pultrusion is extruded a specified length from the plastic extrusion machine such that each of the plurality of polymer composites is able to be manufactured on a per application basis. For some applications, the pultrusion is frequently segmented such that each of the plurality of polymer composites is a pellet, which allows for favorable thermodynamic properties in casting, molding, or injection molding processes. In some other applications, such as three dimensional printing, the pultrusion is sparsely segmented such that the plurality of polymer composites is an elongated cord which is able to be continuously fed into various three dimensional manufacturing machines.

The plurality of polymer composites has applications in material constructions including injection molding. The dispersal of the plurality of tungsten sulfide nanotubes throughout the plurality of polymer composites in order to reinforce the material structure, increasing the tensile strength and durability for the products manufactured using the plurality of polymer composites. The inclusion of the plurality of tungsten sulfide nanotubes does not negatively affect the rheological and textural properties such that the plurality of polymer composites behave similarly as the original nylon resin would under the same conditions.

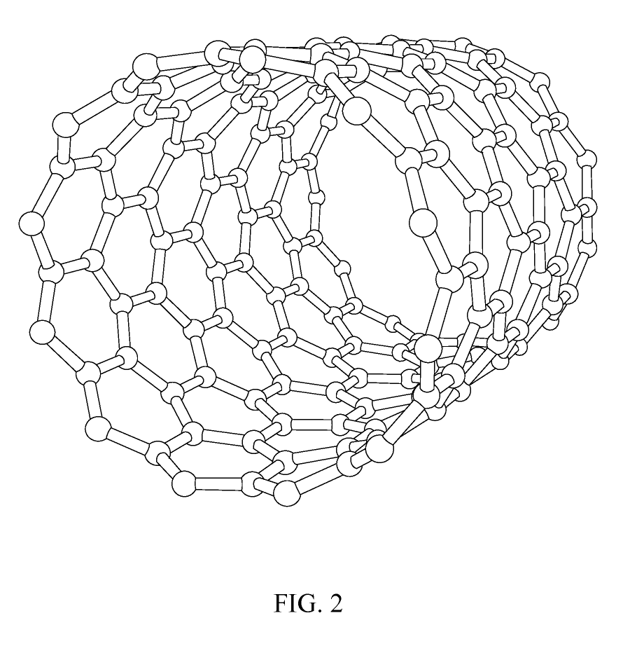

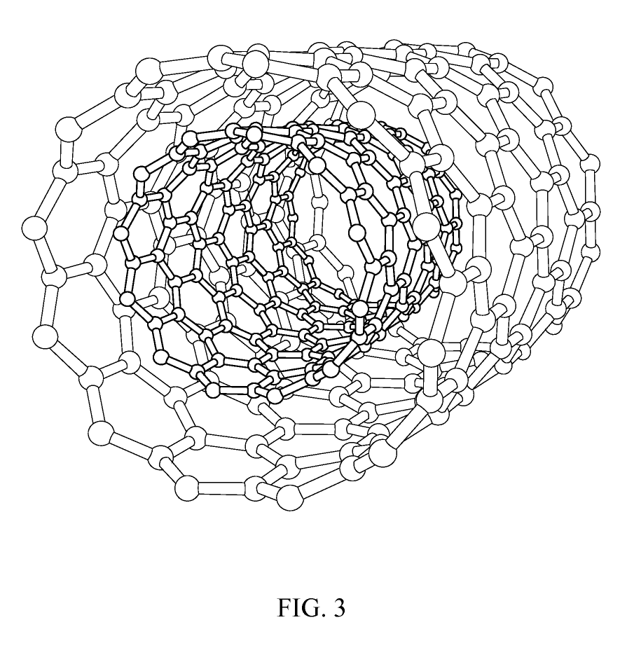

The structure for each of the plurality of tungsten sulfide nanotubes allows for the favorable material properties of the plurality of polymer composites. Each of the plurality is configured as a cylindrical lattice structure, in accordance to FIG. 2. The cylindrical lattice structure allows for more elastic deformation as pressure is applied laterally to each of the plurality of tungsten sulfide nanotubes. In some embodiments of the present invention, a fraction of the plurality of tungsten sulfide nanotubes are concentrically positioned within each other, as shown in FIG. 3. Therefore, the fraction of the plurality of tungsten sulfide concentrically positioned within another further reinforcing the tungsten sulfide nanotube from lateral deformation increasing the structural stability for the plurality of tungsten sulfide nanotubes. Each of the plurality of tungsten sulfide nanotubes is preferred to be between five and eight nanometers in diameter and between ten and twelve nanometers in length. These dimensions for each of the plurality of tungsten sulfide nanotubes provides sufficient surface area to be enveloped by the fluid nylon resin in order to have sufficient structural support within the plurality of polymer composites.

Although the invention has been explained in relation to its preferred embodiment, it is to be understood that many other possible modifications and variations can be made without departing from the spirit and scope of the invention as hereinafter claimed.

What is claimed is:

1. A method of manufacturing a high performance polymer and nanotube composite comprises the steps of:
providing a plurality of nylon resin pellets, a plurality of tungsten sulfide nanotubes, and a plastic extrusion machine;
grinding the plurality of nylon resin pellets into a nylon resin powder;
blending the plurality of tungsten sulfide nanotubes into the nylon resin powder to form a heterogeneous mixture in a solid state;
loading the heterogeneous mixture into the plastic extrusion machine;
heating the heterogeneous mixture within the plastic extrusion machine until the heterogeneous mixture is in a fluid state;
extruding the heterogeneous mixture into a pultrusion with the plastic extrusion machine; and
segmenting the pultrusion into a plurality of polymer composites while the pultrusion solidifies from cooling.

2. The method of manufacturing a high performance polymer and nanotube composite, the method as claimed in claim 1 comprises the step of:
frequently segmenting the pultrusion into a plurality of pellets, wherein the plurality of polymer composites is the plurality of pellets.

3. The method of manufacturing a high performance polymer and nanotube composite, the method as claimed in claim 1 comprises the step of:
sparsely segmenting the pultrusion into a plurality of elongated cords, wherein the plurality of polymer composites is the plurality of elongated cords.

4. The method of manufacturing a high performance polymer and nanotube composite, as claimed in claim 1, wherein the heterogeneous mixture is approximately 80% by weight of the nylon resin powder.

5. The method of manufacturing a high performance polymer and nanotube composite, as claimed in claim 1, wherein the heterogeneous mixture is approximately 20% by weight of the plurality of tungsten sulfide nanotubes.

6. The method of manufacturing a high performance polymer and nanotube composite, as claimed in claim 1, wherein each of the plurality of tungsten sulfide nanotubes is configured as a cylindrical lattice structure.

7. The method of manufacturing a high performance polymer and nanotube composite, as claimed in claim 1, wherein a fraction of the plurality of tungsten sulfide nanotubes is concentrically positioned within each other.

8. The method of manufacturing a high performance polymer and nanotube composite, as claimed in claim 1, wherein a diameter for each of the plurality of tungsten sulfide nanotubes is between five nanometers and eight nanometers.

9. The method of manufacturing a high performance polymer and nanotube composite, as claimed in claim 1, wherein a length for each of the plurality of tungsten sulfide nanotubes is between ten nanometers to twelve nanometers.

10. The method of manufacturing a high performance polymer and nanotube composite, as claimed in claim 1, wherein the plurality of nylon resin pellets is polyamide 6/6 polymer.
